(19) United States
(12) Patent Application Publication
(10) Pub. No.: US 2014/0127508 A1
(43) Pub. Date: May 8, 2014

(54) HIGH ASPECT RATIO POLYMER ELONGATE AND ONE-DIMENSIONAL MICRO STRUCTURE FABRICATION

(71) Applicant: The Board of Trustees of the University of llinois, Urbana, IL (US)

(72) Inventors: M. Taher A. Saif, Champaign, IL (US); Jagannathan Rajagopalan, Tempe, AZ (US)

(21) Appl. No.: 14/068,224

(22) Filed: Oct. 31, 2013

Related U.S. Application Data
(60) Provisional application No. 61/723,092, filed on Nov. 6, 2012.

(51) Int. Cl. B29C 45/40

(52) U.S. Cl. CPC B29C 45/40
USPC 428/401; 264/334; 264/161; 264/328.1; 264/219

(57) ABSTRACT

A preferred method of the invention introduces organosilicon polymer into the reservoir of a mold with trenches defining a negative mold impression of a feature that has a high aspect ratio in fluid communication with the micro-dimensioned reservoir. The mold is preferably coated with a low-stiction coating. The polymer is moved via capillary action into the negative mold from the reservoir. The polymer is cured. The polymer is then released from the mold. Preferably, the polymer is soaked in a releasing solution prior to release. Preferably, the polymer is released by gripping cured polymer in the reservoir and gently peeling the cured micropolymer from the mold. In preferred embodiments, the polymer is poly-dimethyl-siloxane (PDMS). A preferred structure formed by methods of the invention is polymer microbeam in a liquid having a length of one to a few millimeters and a stiffness of k<0.1 pN/μm. Aerodynamic features can be created along with the beam. Preferred microbeams can be ten or a few tens of microns deep and wide and a millimeter or a few millimeters long.

### PRIORITY CLAIM AND REFERENCE TO RELATED APPLICATION

The application claims priority under 35 U.S.C. §119 from prior provisional application Ser. No. 61/723,092, which was filed Nov. 6, 2012.

### STATEMENT OF GOVERNMENT INTEREST

This invention was made with government support under contract number NS063405-01 awarded by the National Institutes of Health and under contract number NSF CBET-0939511 awarded by the National Science Foundation. The government has certain rights in the invention.

### FIELD

A field of the invention is micro structures and microsystems. Example applications of the invention include microfluidic systems and mechanobiology such as those used in biochemical assays and other cell studies, e.g., force/deformation and stimuli-response studies.

### BACKGROUND

Soft, polymer-based microdevices and systems have become ubiquitous in biology. Examples include microfluidic systems used to perform complex biochemical assays and micropatterned polymeric substrates used for studying fundamental cellular processes. More recently, these microsystems have found increasing use in studying the effect of force/deformation and mechanical microenvironment on cell behavior. The studies are directed toward determining how cells sense force/deformation and the mechanical properties of their environment, and measure the force/deformation response of cells to mechanical/biochemical stimuli.

Capillary force has been used to form patterns of polymer materials on substrates as a substitute for lithography with application of a PDMS mold. See, e.g., Suh et al., “Capillary Force Lithography: Large-Area Patterning, Self-Organization, and Anisotropic Dewetting,” Adv. Func. Mater. Vol. 12, No. 6+7 (June 2002). Molds are placed upon the surface of a film of polymer that is on a substrate and capillary action is relied upon to fill mold features. There is no disclosure of forming freestanding structures. The entire top surface of the mold must contact the polymer. Additional features are created with application of second molds.

Similarly, capillary forces were used to form to produce complex polymeric micro structures supported on different substrates and to create masks. See, Xia et al., “Micromolding of Polymers in Capillaries: Applications in Microfabrication,” Chem. Mater. Vol. 8, 1558-1567 (1996). Sheet-like structures including patterned features were formed by molding in enclosed, continuous channels formed by conformal contact between a solid support and an elastomeric mold whose surface had been patterned with a relief structure having micrometer-scale dimensions. A PDMS mold is contacted with a surface, and then liquid polymer is placed around the mold. This forms a frame around the mold, in addition to filling channels in the mold. The structures with features were released to various substrates, including on thin films of plastic. Free standing mask patterns were formed by filling channels of a PDMS mold from all sides. After curing, excess polymer that remained outside the PDMS mold formed a frame of a relatively thick, strong polymeric structure around a thinner, more fragile, patterned microstrcuture. The frame could be removed from around the thin, sheet-like micro structure by dissolving or cutting away the support frame. In this method, polymer must wet two different materials—the PDMS mold and the substrate (at least partially). The method was limited to polymers that are non-reactive with both surfaces. In addition, the method is restricted to polymers with low viscosity (<400 cP), and the method would not work with a polymer that would swell the PDMS mold.

Poly(dimethylsiloxane) (PDMS) based micro devices and systems have been extensively used to study biological systems. See, e.g., G. M. Whitesides, et al., Soft lithography in biology and biochemistry,” Annual Reviews in Biomedical Engineering, 3:335-373 (2001); R. Bashir, “Biomems: State-of-the-art in detection, opportunities and prospects,” Advanced Drug Delivery Reviews, 56:1565-1586 (2004). Typical methods create a 3-D replica structure, pour PDMS into it and then squeeze it. See, e.g., Park J, et al., “Real-time measurement of the contractile forces of self-organized cardiomyocytes on hybrid biopolymer microcantilevers,” Anal. Chem. 77 6571-80 (2005); Park J, et al., “Fabrication of complex 3d polymer structures for cell-polymer hybrid systems,” J. Micromech. Microeng. 16 1614-9 (2006). Others have etched PDMS to create the freestanding structures, e.g., D. J. Cappelleri, et al., “A two dimensional vision-based force sensor for microrobotic applications,” Sens. Actuators A: Phys., vol. 171, no. 2, pp. 340-351 (2011).

Many of the initial applications involved microfluidic circuits to perform biochemical assays and micro patterning to study the biochemical aspects of fundamental cellular processes. PDMS based micro devices and systems are also being used to study the mechanics of cells/tissues and the relationship between the mechanical forces/microenvironment and cell/tissue behavior, a field commonly referred to as mechanobiology. See, e.g, N. Li, et al., “Biology on a chip: Microfabrication for studying the behavior of cultured cells. Critical Reviews in Biomedical Engineering,” 31:423-488 (2003); D. Kim, et al., “Microengineered platforms for cell mechanobiology,” Annual Reviews of Biomedical Engineering, 11:203-233 (2009); J. Rajagopalan et al, “Mems sensors and microsystems for cell mechanobiology,” Journal of Micromechanics and Microengineering, 21:054002 (2011).

There have been some interesting mechanobiology studies based on PDMS micro systems. One category of technique is traction force microscopy. N. Q. Balaban, et al, “Force and focal adhesion assembly: A close relationship studied using elastic micropatterned substrates,” Nature cell biology, 3:466-472, (2001); S. Munevar, et al., Traction force microscopy of migrating normal and b-ras transformed 3t3 fibroblasts,” Biophys. J., 80:1744-1757 (2001); Y. L. Wang, et al., Preparation of a flexible, porous polyacrylamide substrate for mechanical studies of cultured cells. Methods in Enzymology, 298:489-496 (1998). Another category is microfabricated post array detectors. J. L. Tan, “Cells lying on a bed of microneedles: An approach to isolate mechanical force,” Proc. Natl. Acad. Sci. USA, 100:1484-1489 (2003); 0. Du Roure, et al., “Force mapping in epithelial cell migration,” Proc. Natl. Acad. Sci. USA, 102:2390-2395 (2005); Y. Zhao, et al., “Cellular mechanics study in cardiac myocytes using pdms pillars array,” Sensors and Actuators, A: Physical, 125:398-404 (2006). Still another category is micro cantilevers that are used measure contractile forces of cells. J. Park, et al., Real-time measurement of the contractile forces of self-organized cardiomyocytes on hybrid biopolymer microcantilevers,” Analytical Chemistry, 77:6571-6580 (2005); Y. Zhao, et al., “Simultaneous orientation and cellular force measurements in adult cardiac myocytes using three-dimensional polymeric microstructures,” Cell motility and the cytoskeleton, 64:718-725 (2007). These techniques primarily focus on determining how cells sense force/deformation and the mechanical properties of their environment, and measuring the force/deformation response of cells/tissues to mechanical/biochemical stimuli.

Flexible polymeric devices have also been studied for use in bio-hybrid actuators. J. Xi, et al., “Self-assembled microdevices driven by muscle. Nature Materials,” 4:180-184 (2005); A. W. Feinberg, et al., “Muscular thin films for building actuators and powering devices. Science,” 317:1366-1370 (2007); V. Chan, et al., “Multi-material bio-fabrication of hydrogel cantilevers and actuators with stereolithography,” Lab on a Chip—Miniaturisation for Chemistry and Biology, 12:88-98 (2012). It has been determined that cells can sense their mechanical micro environment. See, e.g., D. E. Discher, et al., “Tissue cells feel and respond to the stiffness of their substrate,” Science, 310:1139-1143 (2005). There is a strong coupling between the structure and physical properties of the bio-hybrid actuator and the biological processes that power it. J. Kim, et al., “Establishment of a fabrication method for a long-term actuated hybrid cell robot,” Lab on a Chip—Miniaturisation for Chemistry and Biology, 7:1504-1508 (2007).

Flexible polymeric devices have also been used in cell based bio-hybrid actuators. See, e.g., J. Xi, et al, “Self-assembled microdevices driven by muscle,” Nat. Mater., vol. 4, no. 2, pp. 180-184 (2005); A. W. Feinberg, et al., “Muscular thin films for building actuators and powering devices,” Science, vol. 317, no. 5843, pp. 1366-1370 (2007); J. Kim, et al, “Establishment of a fabrication method for a long-term actuated hybrid cell robot,” Lab Chip, vol. 7, no. 11, pp. 1504-1508 (2007); E. Choi, et al, “MEMS-based power generation system using contractile force generated by self-organized cardiomyocytes,” Sens. Actuators B, Chem., vol. 151, no. 1, pp. 291-296 (2010). Physical forces generated by cells are used to power composite cell-polymer structure. Cells respond, however, to their mechanical microenvironment. See, R. J. Pelham, Jr. and Y. Wang, “Cell locomotion and focal adhesions are regulated by substrate flexibility,” in Proc. Natl. Acad. Sci. USA, vol. 94, no. 25, pp. 13661-13665 (1997); D. E. Discher, et al, “Tissue cells feel and respond to the stiffness of their substrate,” Science, vol. 310, no. 5751, pp. 1139-1143 (2005). For this reason, cell migration, proliferation and force generation are affected by mechanical properties of an installed bio-hybrid actuator.

### SUMMARY OF THE INVENTION

The inventors have recognized that reducing both dimensions and stiffness can lead to more efficient bio-machines and power generators and more sensitive sensors and measuring devices. The inventors have determined that advances in research will require structures with less stiffness. The biological forces being measured are extremely small. In addition, structures must provide handling. The inventors have recognized that a strong coupling between the structure and physical properties of a bio-hybrid actuator and the biological processes that power it provides an opportunity to permit more efficient biomachines and power generators. Devices of the invention have very low stiffness and can be one to a few millimeters long.

A preferred method of the invention introduces organosilicon polymer into the reservoir of a mold with trenches defining a negative mold impression of a feature that has a high aspect ratio in fluid communication with the micro-dimensioned reservoir. The mold is preferably coated with a low-stiction coating. The polymer is moved from the reservoir via capillary action into the negative mold. The polymer is cured. The polymer is then released from the mold. Preferably, the polymer is soaked in a releasing solution prior to release. Preferably, the polymer is released by gripping cured polymer in the reservoir and gently peeling the cured micropolymer from the mold. In preferred embodiments, the polymer is poly-dimethyl-siloxane (PDMS). A preferred structure formed by methods of the invention is polymer microbeam suspended in a liquid and having a length of one to a few millimeters and a stiffness of k<0.1 pN/μm. Aerodynamic features can be created along with the beam. Preferred microbeams can be ten or a few tens of microns deep and wide and a millimeter or a few millimeters long.

### BRIEF DESCRIPTION OF THE DRAWINGS

FIGS. 1A-1H illustrates a preferred method for making a mold used in formation of high aspect ratio elongate polymer micro structures and a method for making high aspect ratio elongate polymer micro structures;

FIGS. 2A-2C illustrate example molds formed by the process of FIG. 1 and that can be used for forming simple and complex high aspect ratio elongate one-dimensional polymer micro structures in accordance with embodiments of the invention;

FIGS. 3A-3D show a series of images of liquid PDMS filling up micro channels in a mold via capillary forces in an experiment;

FIGS. 4A-4C are images of experimental PDMS micro cantilever beams after being released from a silicon mold in liquid; FIG. 4D is a plot of the variation in tip position of a free cantilver over a period of 10 h, with a measurement accuracy of ±0.5 μm;

FIGS. 5A-5E are images of experimental PDMS devices having an intricate arrow-head shaped feature, including grooves in surfaces of the feature (FIG. 5C); FIG. 5D shows fibroblasts cultured on the feature and FIG. 5E the feature with cultured fibroblasts after being released from larger are PDMS material of the reservoir;

FIGS. 6A-6F illustrate that the method of FIGS. 1A-H can form rounded cross section elongate micro structures in accordance with the shape of the silicon mold.

### DETAILED DESCRIPTION OF THE PREFERRED EMBODIMENTS

An embodiment of the invention is a fabrication method that can produce elongate and one-dimensional polymer structures that are only a few μm thick and have extremely large aspect ratio (e.g., length to width/thickness approaching 500:1) is developed. A fabrication method of the invention can, for example, create extremely sensitive cantilevers with stiffness less than 1 pN/μm. State of the commercial AFM cantilevers have a stiffness that is ˜10000 times larger. A fabrication method of the invention can also produce micro platforms actuated by mechanically active cells.

Preferred fabrication methods of the invention use polymeric compounds. Particular preferred fabrication methods of the invention use polymeric organosilicon compounds. A specific particular preferred fabrication method of the invention uses poly-dimethyl-siloxane (PDMS) as the polymer for fabrication.

In an example preferred method, a silicon mold with trenches that are, e.g., 10 μm wide and deep and several millimeters long, is fabricated using photolithography and dry etching. The mold can also be formed of other materials in other embodiments, e.g., it can be formed of another polymeric material such as a photoresist, a different semiconductor or an insulator such as glass. The trenches are connected to one or more large wells (several mm in width and length but with the same depth as the trenches, e.g. ˜10 μm) that serve as reservoirs. The entire mold is coated with a non-wettable fluorocarbon solid. A preferred fluorocarbon solid is polytetrafluoroethylene (PTFE) (commercially available as Teflon®). The coating is a thin layer, e.g., ˜100 nm. PDMS is then injected into the reservoirs, spreads to the trench openings and gets drawn into the trenches due to capillary action. The trenches get filled in a few minutes, after which the PDMS is cured at higher temperature (60° C.). After curing, the mold is soaked in ethanol which assists in the release of the PDMS structure. The elongated and one-dimensional PDMS micro-beams (replica of the trenches) remain connected to the large reservoirs after release and hence the structures can be easily handled. It would be very difficult to manually release each individual PDMS micro beam, the task is enormously simplified in this case because the micro beams are still attached to the reservoirs. In the first step of the peeling process, the reservoirs, which are thicker and have much larger area, are gently released from the Si mold. Then a small tweezer is used to grasp the released reservoir and slowly peel off the micro beams. Since the tweezer never comes into contact with the micro beams during their release, the damage to the micro beams is considerably reduced. In effect, the reservoir in the Si mold serves two different purposes—a) to fill the micro channels with PDMS, and b) to avoid damage to the PDMS micro beams during release.

One-dimensional polymeric compound micro-structures of the invention have many applications. For example, the micro structures can be used as force sensors to measure extremely small forces (from tens of femtoNewton (fN) to several picoNewton (pN)) exerted by cells. Another application is to use them as microdevices that are actuated by cells. The cell-actuated devices can be used for bio-sensing or serve as the building blocks of cellular machines.

The invention has been tested and example devices and methods carried out in experiments. Experiments have created extremely sensitive cantilever beams with stiffness less than 0.1 pN/μm in PDMS, and micro-platforms actuated by cardiomyocyte cells. The invention also provides the ability to provide complex-shaped micro structures that include features that have high aspect ratios that are unitary with complex shapes that serve additional functions. Intricately patterned microchannels can be created, for example, with the invention. An example device provides a complex aerodynamic shaped microchannel in a system that is connected to microfluidic channels. A preferred embodiment bio-hybrid propulsive device provides a complex head with a long, slender tail. The structure can be provided with grooves.

Preferred embodiments of the invention will now be discussed with respect to the drawings. The drawings may include schematic representations, which will be understood by artisans in view of the general knowledge in the art and the description that follows. Features may be exaggerated in the drawings for emphasis, and features may not be to scale.

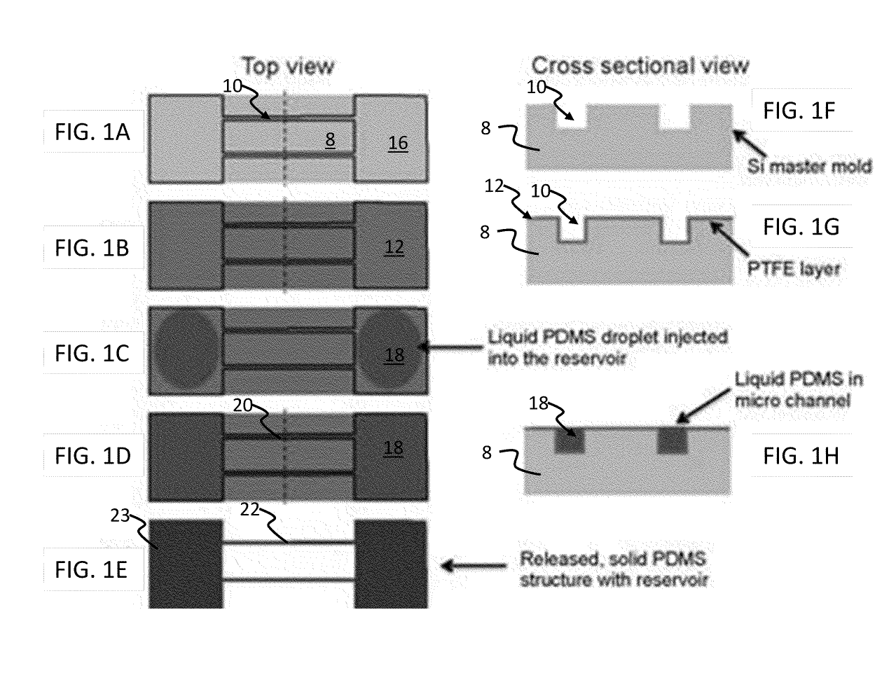

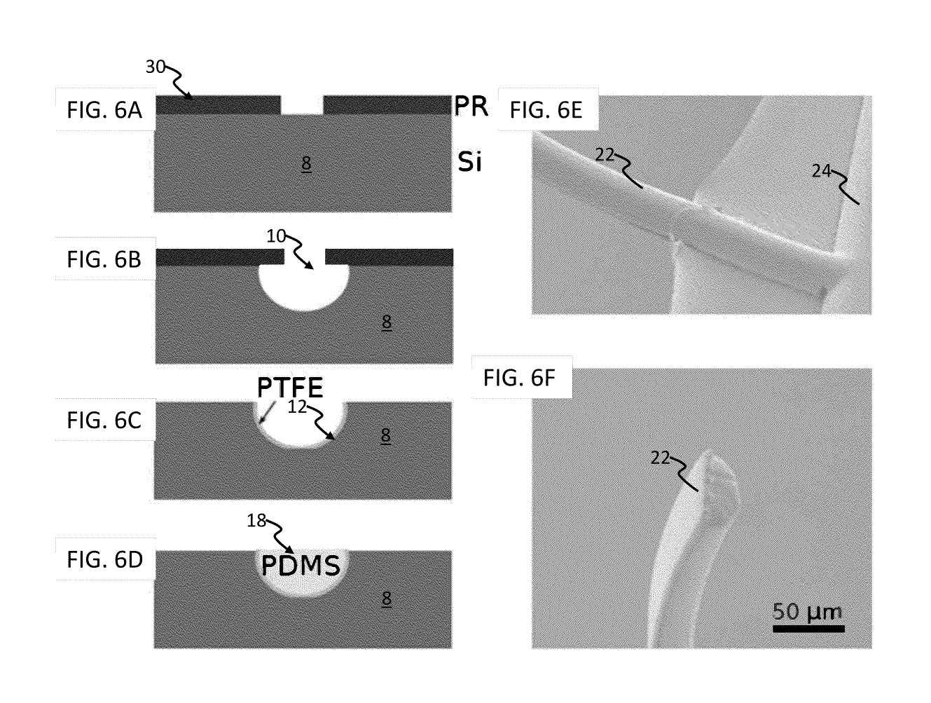

FIGS. 1A-1H shows steps used in forming a mold in a substrate and then forming an elongate and highly flexible polymer structure in accordance with the invention. A substrate 8 can be a semiconductor or insulator, and in a preferred embodiment is a silicon wafer. Lithography is used to form a pattern 10 in the wafer 8. In a preferred embodiment, a Si wafer is spin coated with photoresist and the pattern of the photomask is then transferred to the photoresist layer. The resist layer is then hard baked and the wafer is etched with the pattern 10 of micro channels having a predetermined width. In preferred embodiments, the etching is a deep reactive ion etching that etches the Si wafer to a predetermined depth that established a desired predetermined aspect ratio. The depth of the PDMS structures to be created is set by and the same as the depth of the micro channels. After the Si etch, a thin anti-adhesion layer 12, e.g., about 100 nm of polytetrafluoroethylene (PTFE), is deposited on the entire wafer. The anti-adhesion coating coats the side walls and bottom surfaces of the micro channels that had been etched in the wafer. Liquid polymer 18, e.g., PDMS, is injected into reservoirs 16 that are formed in the micropattern 10. Via capillary action, the polymer fills micro channels 20 in the pattern. The polymer is then cured, and released in FIG. 1E to provide the elongate polymer micro structure 22 between pads 23. Cured PDMS forms pads 23 in the reservoirs 16 that have a much larger area compared to the micro beams 22 (see FIG. 1E and also FIGS. 6E and 6F, which show the beams 22 and pads 23 separate from the mold). This material 23 facilitates gentle release from the mold. A small tweezer can grasp the cured material 23 in the reservoir(s) 16 and be used to slowly peel micro beams 22 from the mold. The tweezer need not contact the micro beams 22 during their release, and damage is considerably reduced. The release in FIG. 1E is preferably conducted in liquid. The micro beams 22 can be very flexible, and can get coiled and damaged if released outside liquid.

The pattern 10 is on top of the mold/substrate 8. The top surface of the mold apart from the channels and reservoirs remains clean, i.e., free from polymer. The polymer, once introduced is limited to the reservoirs 16 and then by capillary action to the micro channels 20. The mold is free from contact with any surface during the introducing. The polymer fills only the channels, as best seen in FIGS. 1C, 1D and 1H. The capillary action pulls liquid polymer in from the reservoirs. This allows very precise beams and other more complicated micro structures to be formed.

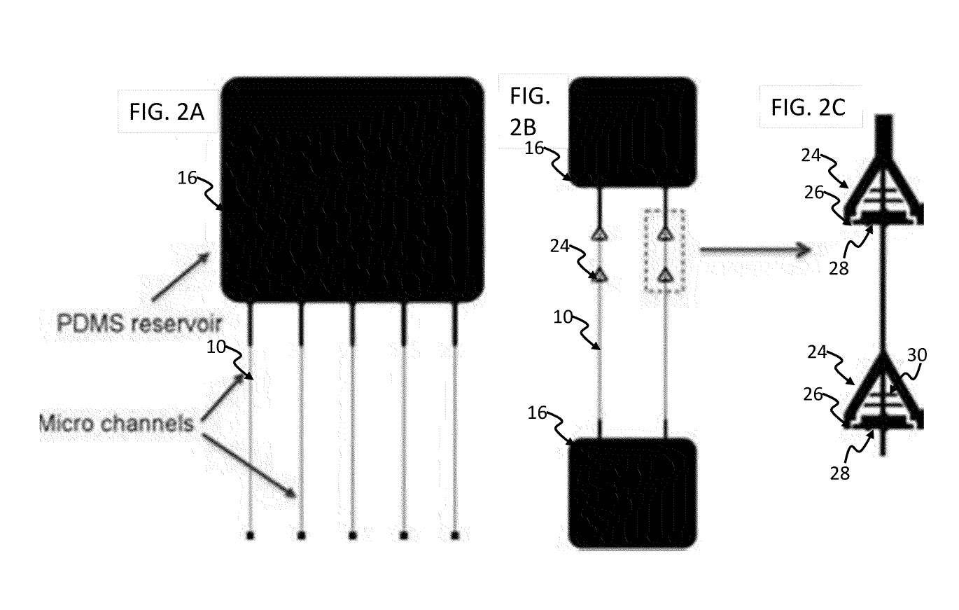

FIGS. 2A-2C illustrate example molds formed by the process of FIG. 1 and that can be used for forming simple and complex high aspect ratio elongate one-dimensional polymer micro structures. As shown in FIGS. 2A and 2B, the substrate includes one or more reservoirs 16 for polymer, such as PDMS, and micro channels 10 extend from the reservoir(s) 16. In FIG. 2A, the micro channels 10 are simple and straight. In FIGS. 2B and 2C, an intricate feature 24 having an overall arrowhead shape with opposing barbs 26, and end bar 28 and internal cross bars 30 is formed. In formation of polymer micro structures of the invention, capillary action is drawn longitudinally into the micro channels 22 from the reservoir(s) 20. Specifically, as the polymer, e.g., PDMS, spreads in the reservoir(s) 20 it comes into contact with inlets of the micro channels 22 and is drawn into the micro channels 22 due to capillary forces. The rate at which the micro channels fill depends a number of factors. The factors include: viscosity of the liquid PDMS; dimensions of the micro channel; and interface energy between PDMS and the anti-adhesion layer. After the micro channels fill, the PDMS is cured. The formed micro structure is then pre-released, such as by soaking in solvent. The micro structure can be removed from the mold by peeling, aided by cured PDMS that remained in the reservoir(s). The released micro structure is an inverse pattern of micro channels in the mold, which become micro beams in the PDMS structure.

Experiments

Testing shows that PDMS with a higher cross-linker to base ratio fills up faster since the cross-linker viscosity is lower compared to the base. Cross-linker to base ratios are preferably in the range of 3:1 to 10:1 and are more preferably 4:1 or 5:1. Experiments demonstrated that micro channels that are about 3 mm long, 15 μm wide and 30 μm deep fill up in a period of 10 minutes when the base to cross-linker ratio is 4:1 (using Dow Corning's Sylgard 184 elastomer). Additional reservoirs are useful to fill micro channels that are longer or have more intricate features, such as the features in FIGS. 2B and 2C. Experiments have used linker to base ratios of 3:1 to 10:1, and in this range, channels with ˜10-20 μm width and depth and length of 3 mm fill in about 5-15 min via capillary action.

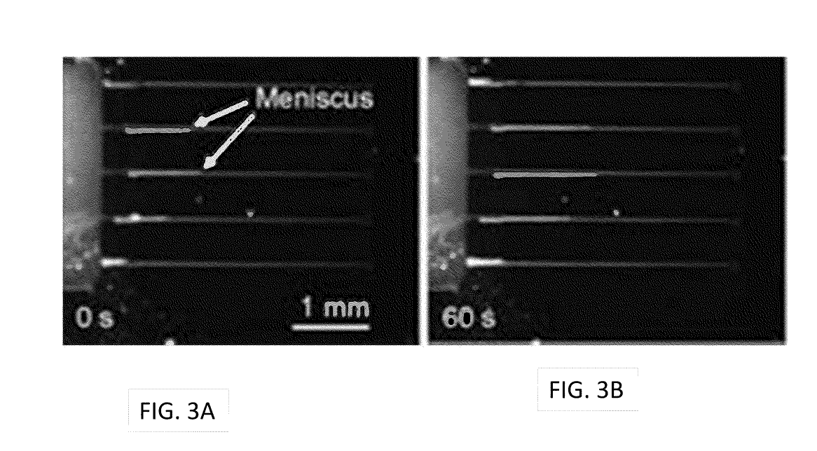

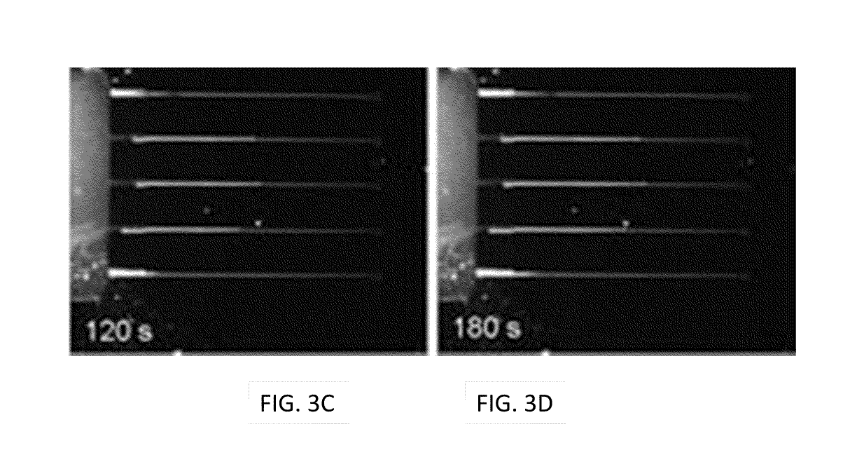

FIGS. 3A-3D show a series of snapshots of liquid PDMS filling up micro channels in a mold via capillary forces in an experiment. As time progresses from FIG. 3A to FIG. 3D, the rate of fluid flow decreases. Drag increases in proportion to the volume of fluid in the micro channel, but the driving force resulting from the reduction in interfacial energy remains constant, which results in the decrease in fluid flow rate.

In experiments, PDMS was cured by baking at 60° C. for 24 hours. The particular curing procedure will depend upon the polymer that is used. Different types of polymers would utilize different curing methods. For example, UV curing can be used for polymers such as use polyurethane, polyacrylate, etc. Pre-release of the PDMS was accomplished with immersion in ethanol for 1-2 hours. Peeling with tweezers from the material in the reservoirs produced very high quality elongate one dimensional beams. Scanning electron micrographs of the pad area from the reservoirs showed a smooth, defect free topography and cantilever beams were obtained by severing the beam from the pad area.

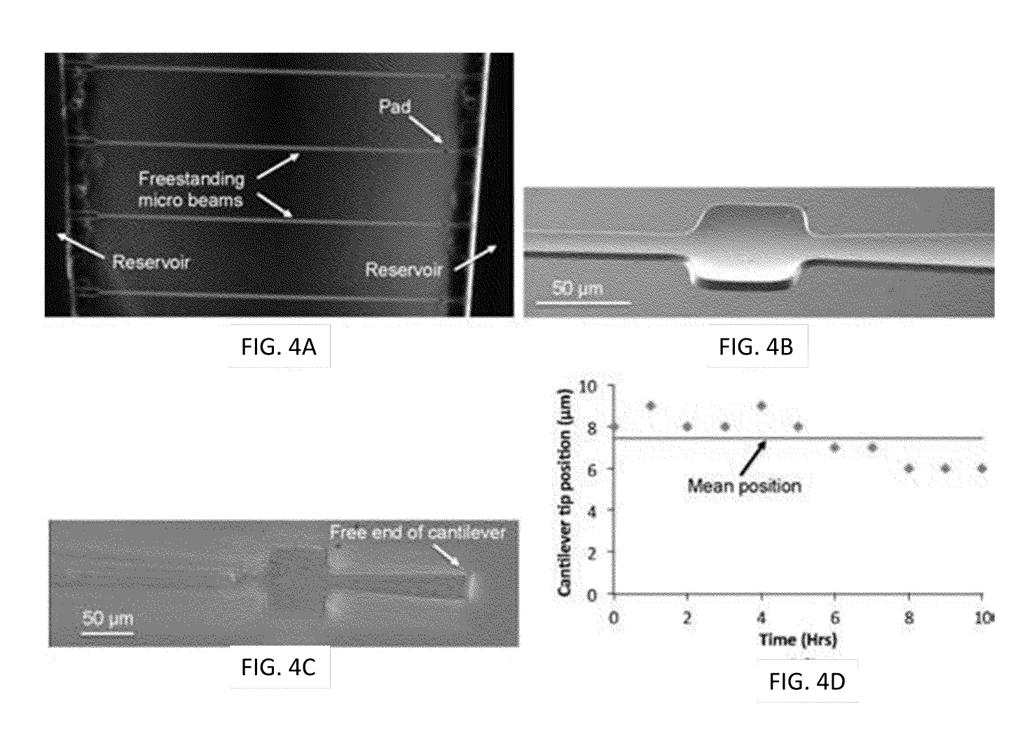

Different types of PDMS micro structures were fabricated in experiments. FIG. 4A shows a set of freestanding PDMS micro beams (with pads) that are attached to the reservoirs at both ends. The magnified image of the pad area (FIG. 4B) reveals a smooth, defect free topography and a nearly perfect reproduction of the pattern on the silicon mold. FIG. 4C shows free cantilever beam, obtained by severing one end of a micro beam from the reservoir, in water. The beam had a stiffness of k<0.1 pN/μm. The length (L), depth (t) and width (w) of the cantilever beam are 3 mm, 8 μm and 20 μm, respectively. Thus, the stiffness, k=Ewt3/4L3, is 0.095 pN/μm (assuming a Young's modulus (E) of 1 MPa), which is more than three orders of magnitude smaller than the stiffness of the most compliant Si or PDMS based micro force sensors known to the inventors. See, e.g., J. Rajagopalan, “Linear high-resolution biomems force sensors with large measurement range,” J. Microelectromech. Syst., vol. 19, no. 6, pp. 1380-1389 (2010); D. J. Cappelleri, G. Piazza, and V. Kumar, “A two dimensional vision-based force sensor for microrobotic applications,” Sens. Actuators A: Phys., vol. 171, no. 2, pp. 340-351 (2011).

The stiffness of such experimental cantilevers is low enough to directly measure mass change of single cells (˜1.5 ng) during a cell cycle. Because the relative density of the cell (ρ_{cell}/ρ_{water}) is around 1.1, the apparent change in mass during the cell cycle is around 0.15 ng. But this extremely small mass change will still cause the PDMS cantilever beam to deflect by 15 μm, which can be easily measured in an optical microscope.

The exemplary extremely low stiffness PDMS cantilevers of the experiments would collapse under self-weight in air. However, the mass density of PDMS (ρ_{pdms}˜0.97 g/cm³) is similar to water (ρ_{water}=1 g/cm³), the effective density of PDMS (ρ_{eff}=ρ_{pdms}−ρ_{water}) in an aqueous environment is very small and negative. As a result, a cantilever (L=2.5 mm, w=10 μm and t=10 μm) with k=0.16 pN/μm would experience only a moderate upward deflection (δ_{buoy}) of 172 μm due to buoyancy. The variable δ_{buoy} (1.5ρ_{eff} L⁴/Et²) scales differently than k (Ewt³/4 L³). Therefore, by reducing t and L proportionately, k can be kept low while significantly reducing δ_{buoy}. Similarly, decreasing w would reduce k without increasing δ_{buoy}. Alternately, ρ_{pdms} can be altered to match the liquid density by adding a small amount of denser micro/nano particles to PDMS. In that case, ρ_{eff}=0 and there would be zero deflection.

Another important quality of cantilevers is that cantilevers should also have minimal fluctuation/drift to ensure reliable force/mass measurements. To verify stability of experimental cantilevers, tip deflection of a free cantilever was measured over a period of 10 hours. During this time, the cantilever showed a maximum fluctuation of only (±1.5 μm) from its mean position, as indicated by the plot in FIG. 4D.

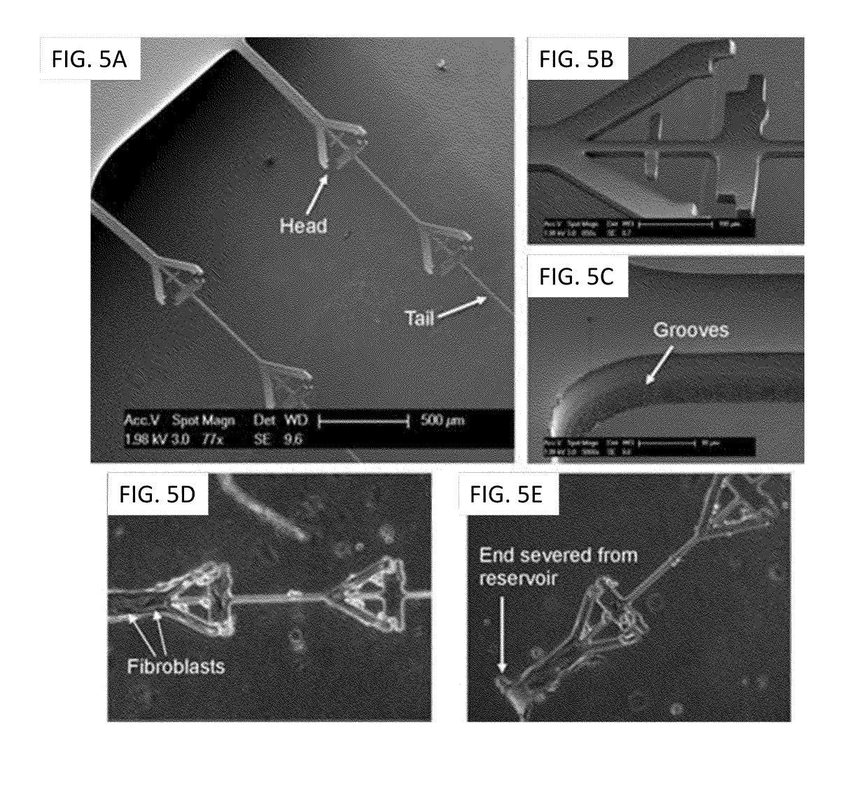

Experiments verified the ability of the present methods to fabricate devices with geometries much more intricate than straight cantilever beams. FIGS. 5A-5E are images of arrow shaped geometries as that are consistent with FIGS. 2B and 2C.

The depth of the PDMS devices shown in FIGS. 5A-E (30-50 μm) is considerably larger than the simple cantilever beams of FIGS. 4A-4C. The successful release of the FIGS. 5A-5E devices demonstrates that deep structures can be released without damage. FIG. 5C shows that sub micron grooves on the surface of the silicon master mold (introduced during the Si etching) are faithfully replicated in the PDMS structure. The PDMS structures of FIG. 5 were functionalized using fibronectin (50 μg/ml) and fibroblasts (FIGS. 5D and 5E) were cultured on them. The structures were shown to be extremely compliant, and the forces generated by fibroblasts cause deflections as large as 1 mm of the tail-like structure when they are released from the reservoir. This testing showed that the PDMS structures can be used as ultra high resolution force/mass sensors in cell mechanobiology studies and serve as substrates for bio-hybrid devices.

FIGS. 6A-6D illustrate the process of FIGS. 1A-1H with a different cross-section the silicon mold. With a layer of photo-resist, the etching of the mold creates a rounded bottom. The process of FIGS. 6C and 6D is identical to the steps in FIGS. 1C, 1D and 1H, and is labeled with common reference numbers. FIGS. 6A and 6B illustrate the use of a photoresist pattern 30 to perform the etching that forms the micro pattern 10. In the case of FIGS. 6A-6D, the micro pattern includes rounded bottom micro channels 20. As known in the art, isotropic wet etching is a technique to produce rounded bottoms. Anisotropic wet etching using KOH can be used to produce trapezoidal or V-shaped cross-sections. Using these cross-sections beams with rounded, trapezoidal or V-shaped cross-sections can be produced. Other cross-sections can also be produced in the mold. Methods for fabrication of different cross-sections are disclosed, for example in Fundamentals of Microfabrication and Nanotechnology, 3rd edition, CRC press (2011) by Marc J. Madou. Methods are described in Volume II (Manufacturing Techniques for Microfabrication and Nanotechnology) of this three part series in Chapter 3 and Chapter 4.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A method for fabricating a high aspect ratio micro structure, comprising:
introducing organosilicon polymer into the reservoir of a mold having a negative mold impression of a feature that has a high aspect ratio in fluid communication with a micro-dimensioned reservoir;
permitting capillary action to move the polymer into the reservoir;
curing the polymer;
releasing the polymer from the mold.

2. The method of claim 1, wherein the releasing is conducted with the mold and the cured micropolymer immersed in liquid.

3. The method of claim 2, further comprising severing the material that cured in the reservoir.

4. The method of claim 1, wherein the mold comprises a plurality of micro-dimensioned reservoirs.

5. The method of claim 1, wherein the polymer comprises poly-dimethyl-siloxane (PDMS).

6. The method of claim 5, wherein the PDMS has a cross-linker to base ratio of ˜4:1.

7. The method of claim 1, wherein the low stiction coating comprises a non-wettable fluorocarbon solid.

8. The method of claim 1, wherein the non-wettable fluorocarbon solid comprises polytetrafluoroethylene (PTFE).

9. The method of claim 8, wherein the releasing solution comprises ethanol.

10. The method of claim 1, wherein said introducing comprises injecting.

11. The method of claim 10, wherein the features are formed on the top of the mold and the mold is exposed and free from any other surface during said introducing.

12. The method of claim 1, further comprising a step of functionalizing the cured and released polymer with biological material.

13. The method of claim 12, wherein the biological material comprises fibronectin.

14. The method of claim 12, wherein the biological material comprises fibroblasts.

15. The method of claim 1, wherein the feature comprises a micro beam.

16. The method of claim 15, wherein the micro beam is ten or a few tens of microns deep and wide and a millimeter or a few millimeters long.

17. The method of claim 15, wherein the feature further comprises an intricate aerodynamic shape.

18. The method of claim 17, wherein the feature comprises an arrow shape with internal cross bars and an end bar.

19. The method of claim 1, further comprising forming the mold, wherein the forming comprises:
forming a mold with trenches defining a negative mold impression of a feature that has a high aspect ratio in fluid communication a micro-dimensioned reservoir; and
coating the mold with a low-stiction coating.

20. The method of claim 1, further comprising a step of soaking the polymer in a releasing solution prior to said releasing.

21. The method of claim 20, wherein said releasing comprises gripping cured polymer in the reservoir and gently peeling the cured polymer away from the mold.

22. The method of claim 21, wherein the peeling is conducted with the mold and the cured polymer immersed in liquid.

23. A polymer microbeam suspended in a liquid and having a length of one to a few millimeters and a stiffness of k<0.1 pN/μm.

24. The microbeam of claim 20, further comprising an intricate aerodynamic feature.
